(19) United States
(12) Patent Application Publication
(10) Pub. No.: US 2009/0168814 A1
(43) Pub. Date: Jul. 2, 2009

(54) Second Harmonic Generation Laser System

(76) Inventor: Martin Achtenhagen, Plano, TX (US)

Correspondence Address: SLATER & MATSIL, L.L.P., 17950 PRESTON RD, SUITE 1000, DALLAS, TX, 75252-5793, US

(21) Appl. No.: 11/968,549

(22) Filed: Jan. 2, 2008

(51) Int. Cl. H01S 3/30

(52) U.S. Cl. 372/6

(57) ABSTRACT

A method of manufacturing a second harmonic laser system is provided. A seed laser is optically coupled to a first port of a polarizing beam splitter using a polarization maintaining fiber. A first end of a non-polarization maintaining doped optical fiber is optically coupled to a second port of the polarizing beam splitter. A second end of a non-polarization maintaining doped optical fiber is optically connected to a rotator/reflector. A third port of the polarizing beam splitter is optically coupled to a nonlinear crystal.

### CROSS-REFERENCE TO RELATED APPLICATIONS

This application relates to the following co-pending and commonly assigned patent application: Ser. No. 11/873,975, filed Oct. 17, 2007, entitled System and Method of Providing Second Harmonic Generation (SHG) Light in a Single Pass, which application is hereby incorporated herein by reference.

### TECHNICAL FIELD

Embodiments of the present invention relate generally to a system, a method of producing second harmonic generation light, and a method of manufacturing such system, and more particularly to a second harmonic generation laser system, method and method of manufacture that has limited implementation of polarization maintaining fibers and efficiently uses doped optical fiber.

### BACKGROUND

A laser is an optical source that emits photons in a coherent beam. Laser light is typically a single frequency or color, and emitted in a narrow beam. Laser action is explained by the theories of quantum mechanics and thermodynamics. Many materials have been found to have the required characteristics to form the laser gain medium needed to power a laser, and these have led to the development of many types of lasers with different characteristics suitable for different applications.

In a semiconductor laser, the active medium is a semiconductor. A common type of semiconductor laser is formed from a p-n junction, a region where p-type and n-type semiconductors meet, and is powered by injected electrical current. As in other lasers, the gain region of the semiconductor laser is surrounded by an optical cavity. An optical cavity is an arrangement of mirrors, or reflectors, that form, for example, a standing wave cavity resonator for light waves. Optical cavities surround the gain region and provide feedback of the laser light. In a simple form of semiconductor laser, for example a laser diode, an optical waveguide may be formed in epitaxial layers, such that the light is confined to a relatively narrow area perpendicular (and parallel) to the direction of light propagation.

The frequency of the emitted light may depend on the characteristics of the gain medium. Some colors, typically in the blue-green visible range, may be difficult to produce using a single laser gain medium alone. Therefore, frequency doubling may be used to generate light. In frequency doubling, a fundamental laser frequency is introduced into a nonlinear medium and a portion of the fundamental frequency light is doubled. Frequency doubling in nonlinear material, also called second harmonic generation (SHG), is a nonlinear optical process, in which photons interacting with a nonlinear material are effectively combined to form new photons with twice the energy and, therefore, twice the frequency and half the wavelength of the initial photons.

Current methods for SHG may be too expensive for some laser applications. Generating second harmonic light at a low cost is a challenge for the laser industry.

### SUMMARY OF THE INVENTION

In accordance with an illustrative embodiment, a laser system providing second harmonic generation (SHG) light is provided. The laser system comprises a first section of polarization maintaining (PM) fiber, and a seed laser, wherein the seed laser provides a first polarization of fundamental light to the first section of PM fiber. A polarization beam splitter (PBS) directs the first polarization of fundamental light to a first light path, and a second polarization of fundamental light to a second light path. A doped optical fiber is within the first light path. A laser pump provides energy to the doped optical fiber. A wavelength division multiplexer (WDM) adds the energy from the laser pump to the doped optical fiber. A rotator/mirror accepts a first polarization of fundamental light and reflects a second polarization of fundamental light. A second section of PM fiber is within the second light path. An SHG crystal is optically coupled to the second section of PM fiber, and an outcoupler outcouples a second harmonic light, generated within the SHG crystal, from the laser system.

In accordance with another aspect of an illustrative embodiment, a method of generating a second harmonic light is provided. A first polarization of a fundamental light is produced in a seed laser. The first polarization of the fundamental light is maintained from the seed laser to a polarizing beam splitter. The first polarization of the fundamental light is directed from the polarizing beam splitter to a doped optical fiber. The fundamental light is amplified in a first pass of the doped optical fiber, wherein the first polarization of the fundamental light is allowed to become undefined, forming a second polarization of the fundamental light. The second polarization of the fundamental light is rotated and reflected to form a third polarization of the fundamental light. The third polarization of the fundamental light is amplified in a second pass of the doped optical fiber, wherein the third polarization of the fundamental light is allowed to become undefined, forming a fourth polarization of the fundamental light. The fourth polarization of the fundamental light is directed to a nonlinear crystal while maintaining the fourth polarization of the fundamental light. A second harmonic light is generated, using the fourth polarization of the fundamental light. The second harmonic light is outcoupled.

In accordance with yet another aspect of the illustrative embodiments, a method of manufacturing a second harmonic laser system is provided. A seed laser is optically coupled to a first port of a polarizing beam splitter using a polarization maintaining fiber. A first end of a non-polarization maintaining doped optical fiber is optically coupled to a second port of the polarizing beam splitter. A second end of a non-polarization maintaining doped optical fiber is optically coupled to a rotator/reflector. A third port of the polarizing beam splitter is optically coupled to a nonlinear crystal.

An advantage of an illustrative embodiment may be a lower cost of outputting high power blue-green coherent light. A further advantage of an illustrative embodiment is the availability of components for manufacture of the improved laser system.

The foregoing has outlined rather broadly the features and technical advantages of an illustrative embodiment in order that the detailed description of the invention that follows may be better understood. Additional features and advantages of an illustrative embodiment will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the illustrative embodiments as set forth in the appended claims.

### BRIEF DESCRIPTION OF THE DRAWINGS

For a more complete understanding of the illustrative embodiments, and the advantages thereof, reference is now made to the following descriptions taken in conjunction with the accompanying drawings, in which:

FIG. 1 is a top level schematic of an SHG laser system;

FIG. 2 is a flow chart illustrating a method of generating second harmonic light; and

FIG. 3 is a flow chart of a method of manufacturing an SHG laser system.

The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that an illustrative embodiment provides many applicable inventive concepts that can be embodied in a wide variety of specific contexts. The specific embodiments discussed are merely illustrative of specific ways to make and use the invention, and do not limit the scope of the invention.

The present invention will be described with respect to illustrative embodiments in a specific context, namely a continuous wave semiconductor laser system operating in the blue-green visible light range. The invention may also be applied, however, to other semiconductor lasers employing pulsed operation.

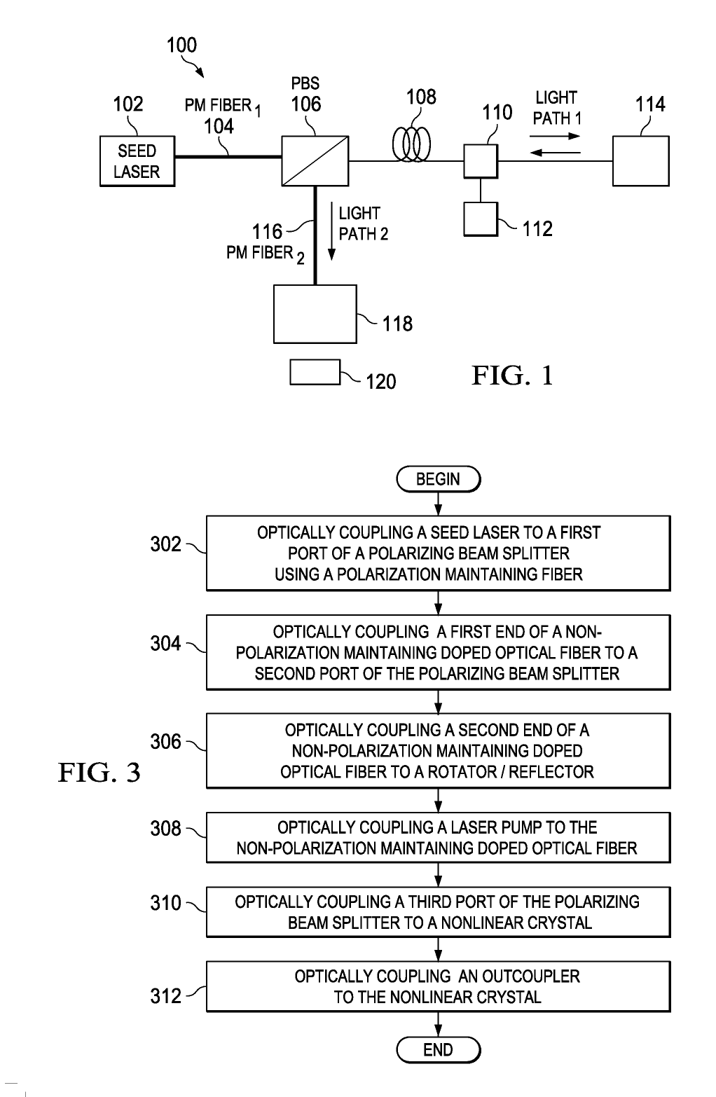

With reference now to FIG. 1, there is shown a top-level schematic of a second harmonic generation (SHG) laser system 100. Components shown are semiconductor seed laser 102, polarization maintaining section 1 (PM fiber₁) 104, a polarizing beam splitter (PBS) 106, doped optical fiber 108, wavelength division multiplexer (WDM) 110, laser pump 112, rotator/reflector 114, polarization maintaining section 2 (PM fiber₂) 116, nonlinear crystal 118, and outcoupler 120.

Seed laser 102, producing fundamental light (ω), has a gain region comprising laser active material. The fundamental light may be, for example, an infra-red (IR) light, although other frequencies may be produced as a fundamental light. The term “light” herein refers to electromagnetic radiation whether or not in the visible frequency range.

A seed laser comprises an active laser medium, or gain medium, and a resonant optical cavity. The gain medium transfers external energy into the laser beam. The area of the laser in which this transfer occurs is called the gain region. It is a material of controlled purity, size, concentration, and shape, which amplifies the beam by the quantum mechanical process of stimulated emission. The gain region is pumped, or energized, by an external energy source. Examples of pump sources include electricity and light. The pump energy is absorbed by the laser medium, placing some of its particles into excited quantum states. When the number of particles in one excited state exceeds the number of particles in some lower-energy state, population inversion is achieved. In this condition, an optical beam passing through the gain region produces more stimulated emission than the stimulated absorption, so the optical beam is amplified. The light generated by stimulated emission is very similar to the input light in terms of wavelength, phase, and polarization. This feature gives laser light its characteristic coherence, and allows it to maintain the uniform polarization and wavelength established by the optical cavity design.

Semiconductor lasers within the scope of the illustrative embodiments generally may be based upon one of four different types of materials, depending upon the wavelength region of interest. Three of the materials are III-V semiconductors, consisting of materials in columns III and V of the periodic table. Examples of column III elements include aluminum (Al), gallium (Ga), indium (In), and thallium (Tl), and examples of column V elements are nitrogen (N), phosphorus (P), arsenic (As), and antimony (Sb). Semiconductor lasers in the near infrared and extending into the visible may be based on GaAs/AlGaAs layers. Indium phosphide (IP) may be used to produce lasers in the 1.5 μm wavelength region with InP/InGaAlP layered materials. Gallium nitride (GaN) may be used for blue and ultraviolet lasers.

Other materials within the scope of the illustrative embodiments are based on II-VI compounds, consisting of materials in columns II and VI of the periodic table. Examples of column II elements are zinc (Zn) and cadmium (Cd). Examples of column VI elements are sulfur (S), selenium (Se), and tellurium (Te). An example II-VI compound is zinc selenide (ZnSe). Many more compounds may be used for semiconductor lasers, producing lasers of various wavelengths, and all of them are within the scope of the present invention.

Seed laser 102 may comprise, for example, a high-power DBR laser or the like. A high power DBR laser may comprise a gain region and a DBR that is formed in the semiconductor material. A distributed Bragg reflector (DBR) may be a reflector that is formed from multiple layers of alternating materials with a varying refractive index, or by periodic variation of some characteristic (such as height) of a dielectric waveguide, resulting in periodic variation in the effective refractive index in the guide. Each layer boundary causes a partial reflection of an optical wave. For waves whose wavelength is close to four times the optical thickness of the layers, the many reflections combine with constructive interference, and the layers act as a high-quality reflector. Therefore, those of ordinary skill in the art will recognize that a DBR laser is a frequency stabilized semiconductor laser.

A DBR laser may be configured, for example, with a DBR structure on one side of a gain region, and a mirror structure on the opposing side, that act to set up the resonant condition for lasing. A DBR laser may also be configured with two DBR structures with an outcoupler situated between a DBR structure and the gain region. In any case, fundamental light (ω) is emitted from seed laser 102 into PM fiber₁ 104.

PM fiber₁ 104 may be an optical fiber with a strong built-in birefringence, preserving the properly oriented linear polarization of an input beam. Birefringence is a property wherein the refractive index depends on polarization direction (direction of the electric field). PM fiber is typically an expensive component of a laser system, thus an advantage of an illustrative embodiment is the limited use of PM fiber. Substantially no PM fiber is used in the first light path.

Fundamental light (ω) has a specific polarization, P₁, termed ωP₁ as ω enters PM fiber₁ 104. PM fiber₁ 104 maintains ωP₁ as ω enters PBS 106. Polarizing beam splitter (PBS) 106 is an optical device that manipulates polarized light. A beam splitter is an optical device that splits a beam of light in two. Polarizing beam splitters, such as, for example, a Wollaston prism may use birefringent materials, splitting light into beams of differing polarization. Therefore, light of one polarization will be directed differently than light of another polarization in PBS 106. Upon laser system startup, substantially all of ωP₁ is directed through PBS in the direction of light path 1. Since light path 1 consists of substantially no PM fiber, the polarization of the fundamental beam becomes undefined, forming ωP₂.

As ω passes through doped optical fiber 108, ω is amplified. The amplification is based on stimulated emission. The gain medium in doped optical fiber 108 contains some atoms, ions, or molecules in an excited state, which can be stimulated by ω to emit more light into the same radiation modes as ω. The gain media, in doped optical fiber 108, may be insulators doped with some laser-active ions. The laser-active ions may be, for example, rare-earth ions or transition-metal ions. Doped optical fiber 108 may be doped with, for example, ytterbium, erbium, neodymium, praseodymium, or thulium and the like. The dopant in doped optical fiber 108 may be pumped with energy in the form of light from pump laser 112, such as a fiber-coupled diode laser or the like. The pump light propagates through the doped optical fiber together with the signal to be amplified. Doped optical fiber 108 may operate on quasi-three-level transitions. When a certain excitation level is exceeded, actual amplification may take place. Doped optical fiber 108 may be double clad.

A double clad doped optical fiber may be surrounded by an inner cladding in which the pump light propagates. The core may be doped. The pump light may be somewhat restricted to the inner cladding by an outer cladding that has a lower refractive index. However, the pump light may also propagate in the single-mode core, where it can be absorbed by the laser-active ions.

Pump laser 112 adds energy to doped optical fiber 108 through WDM 110. Pump laser 112 may be, for example a laser diode, a plurality of laser diodes or the like. More than one laser pump may be optically coupled to WDM 110 and therefore energy from a plurality of laser pumps may be provided to WDM 110 and thus to doped optical fiber 108.

WDM 110 may use a method wherein optical signals, which may have different wavelengths, are combined and transmitted together into doped optical fiber 108. WDM 110 adds the energy from pump laser(s) 112 to doped optical fiber 108. Wavelength division multiplexers are known components of optical systems and therefore will not be discussed further herein. Doped optical fiber 108 may then store the energy in the form of excited energy states. Acting as a template as it passes through doped optical fiber 108, ω is amplified.

Doped optical fiber 108 is non-polarization maintaining, therefore the polarization of ω may change orientation within doped optical fiber 108 and be therefore undefined. Advantages to configuring the doped optical fiber in a non-polarization maintaining fiber is that the non-PM fiber may be less expensive, easier to splice, and easier to obtain.

WDM 110 will pass amplified ω through non-PM fiber to rotator/reflector 114. A component of rotator/reflector 114 may be a Faraday rotator. A Faraday rotator is an optical device that rotates the polarization of light due to the Faraday Effect. The Faraday Effect is a result of ferromagnetic resonance when the permittivity of a material varies by position. This resonance causes light to be decomposed into two circularly polarized rays, which propagate at different speeds, a property known as circular birefringence. The rays can be considered to re-combine upon emergence from the medium; however, owing to the difference in propagation speed, they recombine with a net phase offset, resulting in a rotation of the angle of linear polarization. Therefore, as ω is rotated, reflected, and then further rotated by rotator/reflector 114, the polarization of reflected light, ωP₃ is the opposite of the undefined polarization of ωP₂. ωP₃ travels in the opposite direction of ωP₂ along light path 1.

The fundamental light is further amplified as ωP₃ passes through doped optical fiber 108 a second time. An advantage of an illustrated embodiment is the cost savings of doubling the amplification effect of the amplification components.

Although ωP₂ becomes undefined in light path 1 because the doped optical fiber is non-polarization maintaining, ωP₃ is also undefined, but opposite in polarity from ωP₂ due to rotator/reflector 114. Therefore, as ωP₃ enters PBS 106, ωP₃ is deflected to light path 2. As laser system 100 continues to function, PBS 106 will simultaneously deflect fundamental light ωP₁ coming from seed laser 102 to light path 1 and ωP₃ returning from rotator/reflector 114 to light path 2. Thus, it is an advantage of an illustrative embodiment that the doubly amplified ωP₃ is directed to nonlinear crystal 118, thereby maximizing the use of nonlinear crystal 118.

The polarization of ωP₃ is then maintained in PM fiber₂. PM fiber₂ is optically coupled to nonlinear crystal 118. Within nonlinear crystal 118, the fundamental light (ωP₃) is used to generate second harmonic light (2ω). Outcoupler 120 outcouples second harmonic light 2ω emitted from nonlinear crystal 118 from laser system 100. Outcoupler 120 may or may not include additional filters and lens.

Laser system 100, in accordance with an illustrative embodiment, may be a single pass configuration. In other words, the fundamental light has a single pass at second harmonic (2ω) generation. Fundamental light (ω) may be focused into nonlinear crystal 118. Boyd-Kleinman optimum focusing condition may be implemented. Both ω and 2ω exit nonlinear crystal 118. Fundamental light (ω) exiting nonlinear crystal 118 is not fed back into seed laser 102. Thus, ω has a single opportunity for generation into 2ω. Depending on the application, the remaining fundamental beam exiting the system may be filtered out of laser system 100 output.

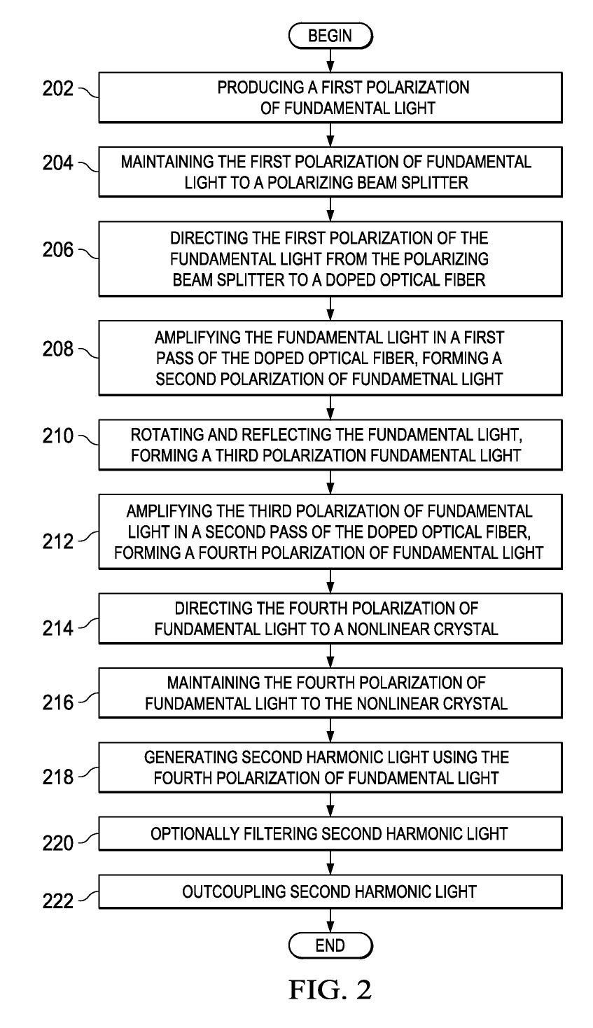

Turning now to FIG. 2, a flow chart illustrating a method of generating second harmonic light is shown. The method comprises producing a first polarization of a fundamental light in a seed laser (step 202). The first polarization of the fundamental light is maintained from the seed laser to a polarizing beam splitter (step 204). The first polarization of the fundamental light is directed from the polarizing beam splitter to a doped optical fiber (step 206). The fundamental light in a first pass of the doped optical fiber is amplified. Within the doped optical fiber, the first polarization of the fundamental light is allowed to become undefined, forming a second polarization of the fundamental light (step 208). The second polarization of the fundamental light is rotated and reflected, to form a third polarization of the fundamental light (step 210).

The third polarization of the fundamental light is amplified in a second pass of the doped optical fiber. The third polarization of the fundamental light is allowed to become undefined, forming a fourth polarization of the fundamental light (step 212). The fourth polarization of the fundamental light is directed to a nonlinear crystal (step 214). The fourth polarization of the fundamental light is maintained to the nonlinear crystal (step 216). A second harmonic light is generated using the fourth polarization of the fundamental light (step 218). Optionally, the second harmonic light is filtered (step 220), before the second harmonic light is outcoupled from the laser system (222).

Turning now to FIG. 3, a method of manufacturing an SHG laser system is shown. A seed laser is optically coupled to a first port of a polarizing beam splitter using a polarization maintaining fiber (step 302). A first end of a non-polarization maintaining doped optical fiber is optically coupled to a second port of the polarizing beam splitter (step 304). A second end of a non-polarization maintaining doped optical fiber is optically connected to a rotator/reflector (step 306). A laser pump is optically coupled to the non-polarization maintaining doped optical fiber (step 308). A third port of the polarizing beam splitter is optically coupled to a nonlinear crystal (step 310). An outcoupler is optically coupled to the nonlinear crystal (step 312). The light may be filtered before outcoupling.

Although an illustrative embodiment and its advantages have been described in detail, it should be understood that various changes, substitutions, and alterations can be made herein without departing from the spirit and scope of the invention as defined by the appended claims. For example, many of the features and functions discussed above can be implemented in software, hardware, or firmware, or a combination thereof.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A laser system comprising:
a first section of polarization maintaining (PM) fiber;
a seed laser, wherein the seed laser provides a fundamental light to the first section of PM fiber;
a polarization beam splitter (PBS), wherein the PBS directs a first polarization of fundamental light from the first section of PM fiber to a first light path, and a second polarization of fundamental light to a second light path;
a doped optical fiber disposed within the first light path;
at least one laser pump, to provide energy to the doped optical fiber;
a wavelength division multiplexer (WDM), to add the energy from the at least one laser pump to the doped optical fiber;
a rotator/mirror, to receive fundamental light and reflect a second polarization of fundamental light;
a second section of PM fiber disposed within the second light path;
a nonlinear crystal that is optically coupled to the second section of PM fiber; and
an outcoupler to outcouple a second harmonic light, generated within the nonlinear crystal from the laser system.

2. The system of claim 1, wherein the seed laser is a high-power DBR laser.

3. The system of claim 1, wherein the fundamental light is selected from the group consisting of continuous wave and pulsed.

4. The system of claim 1, wherein the doped optical fiber comprises a dopant selected from the group consisting of ytterbium, erbium, neodymium, praseodymium, thulium, and combinations thereof.

5. The system of claim 1, wherein the doped optical fiber is double clad.

6. The system of claim 1, wherein the doped optical fiber is non-polarizing maintaining.

7. The system of claim 1, wherein the nonlinear crystal is selected from a group consisting of PPKTP, PPMgLN, PPLN, and PPSLT.

8. The system of claim 1, wherein the second harmonic light is a blue-green light.

9. The system of claim 1, wherein a plurality of laser pumps provide energy to the doped optical fiber.

10. A method of generating a second harmonic light, comprising:
producing a first polarization of a fundamental light in a seed laser;
maintaining the first polarization of the fundamental light from the seed laser to a polarizing beam splitter;
directing the first polarization of the fundamental light from the polarizing beam splitter to a doped optical fiber;
amplifying the fundamental light in a first pass of the doped optical fiber, wherein the first polarization of the fundamental light is allowed to become undefined, forming a second polarization of the fundamental light;
rotating and reflecting the second polarization of the fundamental light, to form a third polarization of the fundamental light;
amplifying the third polarization of the fundamental light in a second pass of the doped optical fiber, wherein the third polarization of the fundamental light is allowed to become undefined, forming a fourth polarization of the fundamental light;
directing the fourth polarization of the fundamental light to a nonlinear crystal while maintaining the fourth polarization of the fundamental light;
generating a second harmonic light, using the fourth polarization of the fundamental light; and
outcoupling the second harmonic light.

11. The method of claim 10, wherein the producing the first polarization of the fundamental light is accomplished in a high-power DBR laser.

12. The method of claim 10, wherein the producing the first polarization of the fundamental light is selected from the group consisting of a continuous wave operation and a pulsed operation.

13. The method of claim 10, wherein the amplifying the fundamental light in the first pass is accomplished in a doped optical fiber comprising a dopant selected from the group consisting of ytterbium, erbium, neodymium, praseodymium, thulium and combinations thereof.

14. The method of claim 13, wherein the doped optical fiber is double clad.

15. The method of claim 13, wherein the doped optical fiber is non-polarizing maintaining.

16. The method of claim 13, further comprising:
adding a light from an at least one laser pump to the doped optical fiber.

17. The method of claim 10, wherein the generating a second harmonic light generates a light in a visible blue-green light range.

18. The method of claim 10, wherein the generating a second harmonic light is accomplished in a nonlinear crystal selected from a group consisting of PPKTP, PPMgLN, PPLN, and PPSLT.

19. A method of manufacturing a second harmonic laser system, the method comprising:
optically coupling a seed laser to a first port of a polarizing beam splitter using a polarization maintaining fiber;
optically coupling a first end of a non-polarization maintaining doped optical fiber to a second port of the polarizing beam splitter;
optically coupling a second end of a non-polarization maintaining doped optical fiber to a rotator/reflector; and
optically coupling a third port of the polarizing beam splitter to a nonlinear crystal;

20. The method of claim 19 further comprising:
optically coupling at least one laser pump to the non-polarization maintaining doped optical fiber.
